(19) United States
(12) Patent Application Publication
(10) Pub. No.: US 2023/0291501 A1
(43) Pub. Date: Sep. 14, 2023

(54) MULTI-USER ENCODING FOR UNEQUAL MODULATION AND CODING SCHEME ASSIGNMENT IN WIRELESS COMMUNICATION SYSTEMS

(71) Applicant: Intel Corporation, Santa Clara, CA (US)

(72) Inventors: Hao SONG, Santa Clara, CA (US); Qinghua LI, San Ramon, CA (US); Po-Kai HUANG, San Jose, CA (US); Juan FANG, Portland, OR (US); Shlomi VITURI, Tel Aviv (IL); Robert STACEY, Portland, OR (US)

(73) Assignee: Intel Corporation, Santa Clara, CA (US)

(21) Appl. No.: 18/317,859

(22) Filed: May 15, 2023

(51) Int. Cl. H04L 1/00

(52) U.S. Cl. CPC H04L 1/007; H04L 1/0072; H04L 1/0075

(57) ABSTRACT

This disclosure describes systems, methods, and devices related to unequal modulation and coding scheme (unequal MCS). A device may decode user fields or first portions of unequal modulation and coding scheme (UEM) user fields from a first user specific field. The device may determine resource allocations, resource unit (RU) and multiple resource unit (MRU) allocations, based on the order of decoded user fields or the first portions of UEM user fields. The device may identify whether a user is a UEM user based on an indication in a first portion of a UEM user field or a new designed subfield, MCS type subfield, in a first user specific field. The device may decode a second user specific field to retrieve remaining portions of UEM user fields for UEM users to obtain the full set of MCSs.

### TECHNICAL FIELD

This disclosure generally relates to systems and methods for wireless communications and, more particularly, to wireless transmissions using unequal modulation and coding schemes (MCSs) over different spatial streams with multiple-input multiple-output (MIMO) technologies in Wi-Fi/802.11 systems.

### BACKGROUND

Wireless devices are becoming widely prevalent and are increasingly requesting access to wireless channels. In wireless communication systems, efficiently managing users with modulation and coding schemes (MCS) is crucial for optimizing network performance.

### BRIEF DESCRIPTION OF THE DRAWINGS

FIG. 1 is a network diagram illustrating an example network environment for unequal modulation and coding scheme (MCS), in accordance with one or more example embodiments of the present disclosure.

FIG. 2 depicts an illustrative schematic diagram for equal MCS adopted in the current Wi-Fi 7 systems.

FIGS. 3-12 depict illustrative schematic diagrams for unequal MCS, in accordance with one or more example embodiments of the present disclosure.

FIG. 13 illustrates a flow diagram of illustrative process for an illustrative unequal MCS system, in accordance with one or more example embodiments of the present disclosure.

FIG. 14 illustrates a functional diagram of an exemplary communication station that may be suitable for use as a user device, in accordance with one or more example embodiments of the present disclosure.

FIG. 15 illustrates a block diagram of an example machine upon which any of one or more techniques (e.g., methods) may be performed, in accordance with one or more example embodiments of the present disclosure.

FIG. 16 is a block diagram of a radio architecture in accordance with some examples.

FIG. 17 illustrates an example front-end module circuitry for use in the radio architecture of FIG. 16, in accordance with one or more example embodiments of the present disclosure.

FIG. 18 illustrates an example radio IC circuitry for use in the radio architecture of FIG. 16, in accordance with one or more example embodiments of the present disclosure.

FIG. 19 illustrates an example baseband processing circuitry for use in the radio architecture of FIG. 16, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices are becoming widely prevalent and are increasingly requesting access to Wi-Fi systems. Thus, the capacity of Wi-Fi systems should be enhanced to meet the demand. MIMO technologies are promising as it can achieve multiple spatial streams on the same wireless resources. Proper unequal MCSs should be assigned to different spatial streams for high capacity and throughput, as wireless environments on different spatial streams are considerably different. However, current Wi-Fi systems, EHT/Wi-Fi 7, can only support a single MCS. Unequal MCSs over spatial streams are designed and proposed here.

Spatial multiplexing is a promising technology that could significantly enhance wireless transmission throughput by enabling multiple spatial streams transmitted on the same wireless resources simultaneously. Different spatial streams may have various channel conditions when pre-coding is applied, such as singular value decomposition (SVD). For higher throughput, spatial streams with different channel conditions should be assigned with different MCSs fitting to their channel conditions. However, this currently is not supported in the IEEE standards. On one wireless channel, a user may be assigned multiple MCSs used in different spatial streams. As a result, the current user specific field design in EHT-SIG field cannot support the use of unequal MCS, as it can only provide one MCS for each user on its RU (Resource Unit). Hence, there is a need to allow for multiple MCSs for a user. For example, the current user specific field in EHT-SIG field should be redesigned for the use of unequal MCS.

In this disclosure, “unequal MCS” refers to users with distinct or varying MCSs on different spatial streams compared to other users with a single MCS within the same communication system. Wireless environments on different spatial streams are varying due to different MIMO gains, therefore unequal MCSs should be assigned to spatial streams to adapt to their varying wireless environments. Also, traffic on different spatial streams may have different requirements or constraints for their communications, which might include varying data rates, signal quality, or other communication parameters. Unequal MCS users have a UEM (User-Equalization Management) user field that is divided into multiple portions, where each portion can have different sizes or the same size. This UEM user field structure allows the system to accommodate and manage the distinct MCS requirements of unequal MCS users, ensuring that they can communicate efficiently and reliably within the system.

Example embodiments of the present disclosure relate to systems, methods, and devices for user specific field design for unequal modulation and coding scheme (MCS).

In one or more embodiments, designs of the user specific field are presented that support both the conventional equal MCS and the unequal MCSs. In these designs, for an unequal MCS user, the original user specific field is divided into two areas, namely user specific field 1 and user specific field 2.

In one or more embodiments, for an unequal MCS user, user specific field 1 provides necessary information such as unequal MCS user identification and positions of unequal MCS information. Then, the user obtains its unequal MCS information in user specific field 2.

In one or more embodiments, the user specific field in Enhanced High Throughput-Signal (EHT-SIG) is redesigned, introducing a new field, the Unequal MCS (UEM) user field, and new subfields, including UEM user field indicator subfield and MCS type subfield. Although EHT-SIG is given as an example of having the new UEM user field, it should be understood that other SIG fields may also be adapted to include the UEM user field (e.g., EHT-SIG for Wi-Fi 7 or Ultra High Reliability Signal (UHR-SIG) for Wi-Fi 8, etc).

In one or more embodiments, an unequal MCS system may enable the use of Unequal MCS in Wi-Fi systems for higher throughput.

In one or more embodiments, an unequal MCS system may use a MCS subfield in user fields or the first portion of UEM user fields to indicate unequal MCS users. Unequal MCS users can obtain their MCS information from User Specific field 2, which is divided into UEM User encoding blocks. Non-unequal MCS users will have their user fields unchanged, adhering to the conventional EHT PHY specification.

In one or more embodiments, an unequal MCS system may indicate unequal MCS users by encoding EHT-MCS 14 (or another code based on implementation) in the user specific field 1 and the position information of UEM user field portions in User Specific field 2 provided in the User Specific field 1. This approach uses the last 7 bits of an unequal MCS user's 1st portion of the UEM user field to indicate the position of this user's other UEM user field portions in the user specific field 2.

In one or more embodiments, an unequal MCS system may indicate unequal MCS users by other additional bits and provides the position information of UEM user field portions in User Specific field 2 by the User Specific field 1. In this approach, new user fields and UEM user field portions are designed with lengths not limited to 22 bits anymore. The MCS type subfield is introduced to differentiate unequal MCS users from non-unequal MCS users.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

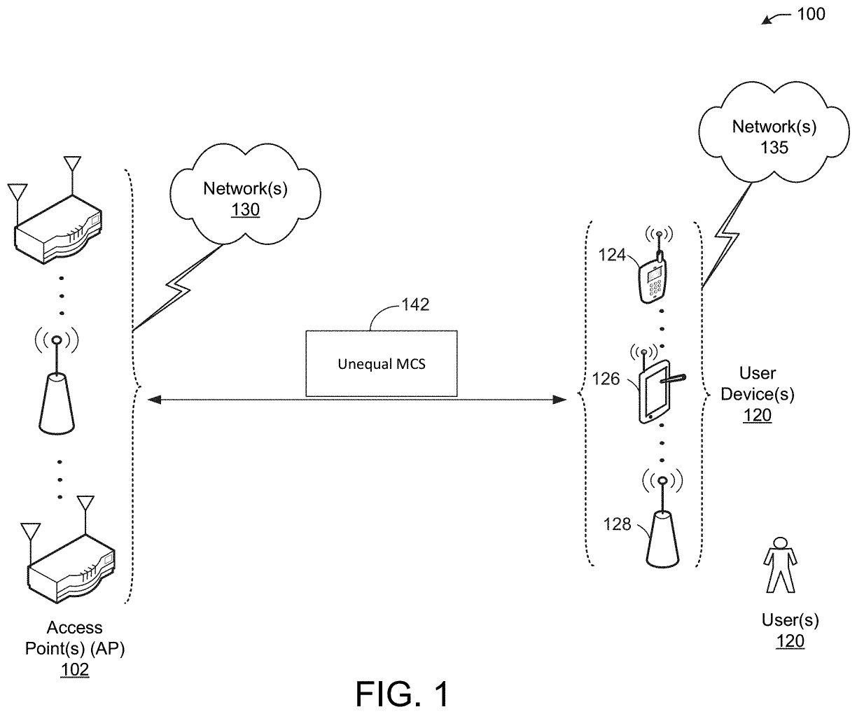

FIG. 1 is a network diagram illustrating an example network environment of unequal MCS, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

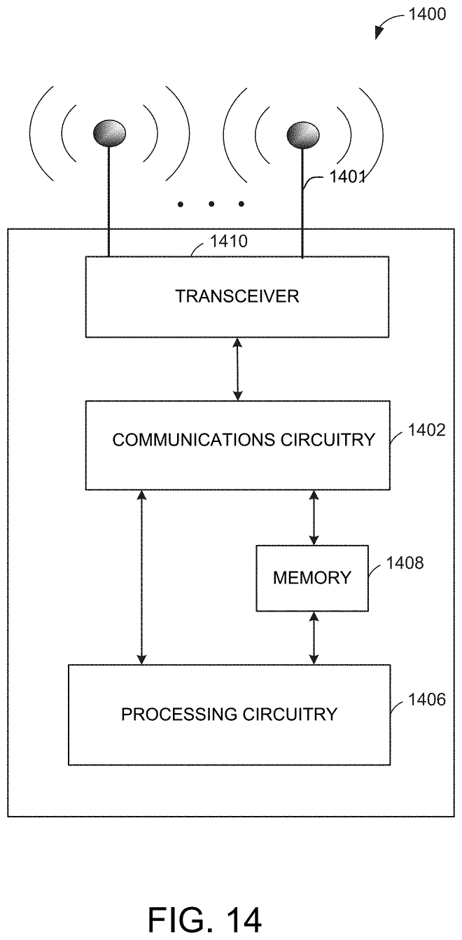

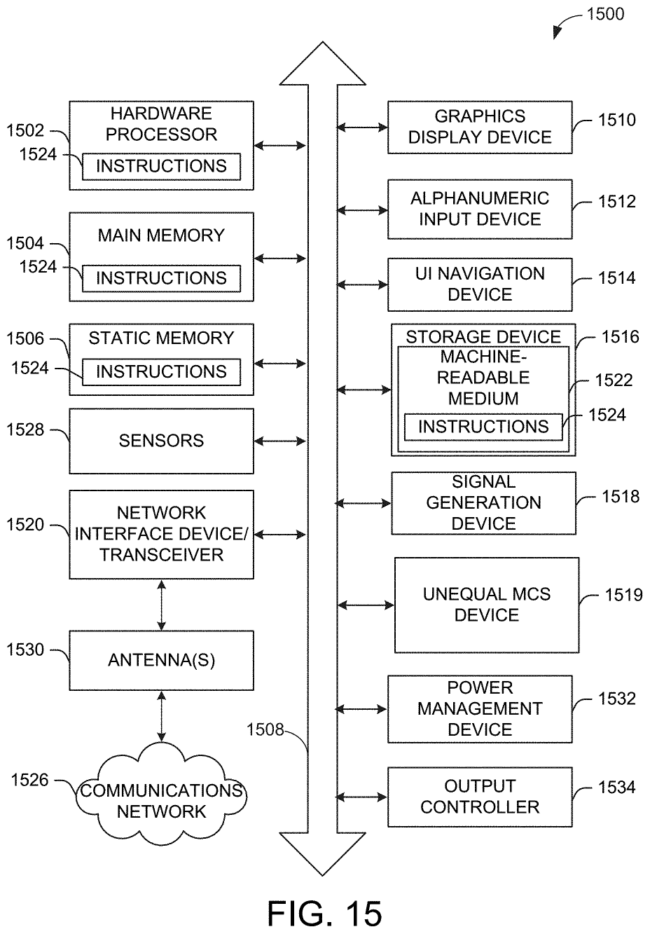

In some embodiments, the user devices 120 and the AP 102 may include one or more computer systems similar to that of the functional diagram of FIG. 14 and/or the example machine/system of FIG. 15.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax, 802.11be, etc.), 6 GHz channels (e.g., 802.11ax, 802.11be, etc.), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an unequal MCS 142 with one or more user devices 120. It is understood that the above descriptions are for purposes of illustration and are not meant to be limiting.

It is understood that the above descriptions are for purposes of illustration and are not meant to be limiting.

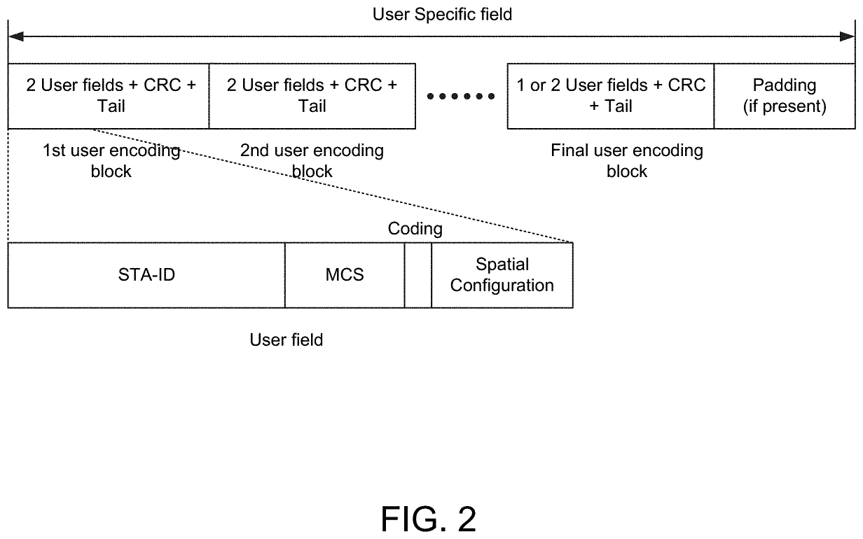

FIG. 2 depicts illustrative schematic diagrams for equal MCS adopted in the current Wi-Fi 7 systems.

Referring to FIG. 2, there is shown a current user specific field. FIG. 2 shows the original user specific field of MU-MIMO defined in the current EHT PHY specifications. A user specific field consists of multiple user encoding blocks, each of which is composed of two user fields followed by cyclic redundancy code (CRC) and Tail. The total number of user fields is equal to the number of users. In other words, each user has one user field, and identifies its user field through STA-ID. Apparently, in the existing user specific field each user can only be assigned one MCS represented by 4-bit binary numbers. To enable unequal MCS, the user specific field should have the capability to indicate multiple MCSs to a user, which will be designed in this proposal.

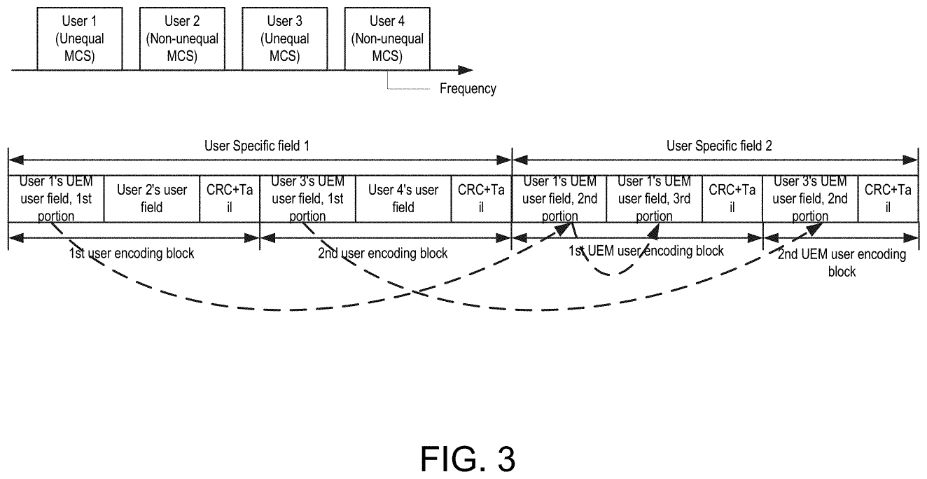

FIGS. 3-12 depict illustrative schematic diagrams for unequal MCS, in accordance with one or more example embodiments of the present disclosure.

In this disclosure, there are two types of user fields. One is normal user fields, referred to as user fields, and the other one is UEM user fields as shown in FIG. 3, which are used for non-unequal MCS users and unequal MCS users, respectively. UEM user fields have at least two portions. The 1st portion of a UEM user field has the same length as a user field, while the length of other portions of a UEM user field may be different from that of a normal user field. User fields and UEM user fields are protected by encoding blocks. User fields and the 1st portions of UEM user fields are encoded before the latter portions of UEM user fields. The user fields and the 1st portions of UEM user fields in the user specific field 1 in FIG. 3 provide the information of the order of resource allocations, which helps users find their allocated wireless resources, RUs or MRUs, based on the resource allocations in the common field. For the example in FIG. 3, there are 4 RUs and each has one user. User 3's 1st portion of UEM user field is at the 3rd place of User Specific field 1. It should be noted that a user encoding block in the user specific field 1 may code across two user fields, two 1st portions of UEM user fields, or one user field and a 1st portion of a UEM user field. A UEM user encoding block may code across two UEM user field portions from the same unequal MCS users or two different users.

In one embodiment, where the total number of users is K, most of user encoding blocks carry two of user fields, or two 1st portions of UEM user fields, or one user field and one 1st portion of UEM user field followed by CRC and Tail. User Specific field 1 carries K fields each of which is either user field or 1st portion of UEM user field. The last user encoding block of User Specific field 1 may carry one user field or one 1st portion of UEM user field, when K is an odd number. In User Specific field 2, the encoding blocks only include other portions of UEM user fields, like 2nd and 3rd portions, except the 1st portions. The order of other portions of UEM user fields in user specific field 2 may follow the order of their 1st portions. Given an example with FIG. 3, as in User Specific field 1 the 1st portion of user 1's UEM user field is before that of user 3. In User Specific field 2, other portions of user 1 are also prior to that of user 3. In another embodiment, the encoding is across User Specific field 1 and User Specific field 2. Namely, the definition or differentiation of the two different types of User Specific fields is not needed. The 2nd and latter portions of UEM user fields start from the K+1th encoding component. Each encoding block has two encoding components.

An example of the proposed user specific field structure is given with the case illustrated in FIG. 3. The frequency channel is divided into 4 RUs and each RU is assigned to one user as indicated by resource allocation subfield of the common field. Through the common field before the user specific fields, all users will know the size and placement of RUs and the number of served users. As user fields and 1st portions of UEM user fields have the same size, users will know occupied bits of the whole user specific field 1 and the positions of each user field and 1st portions of a UEM user field. For example, if there are 4 users and the size of user field and 1st portions of UEM user field is 22 bits, the whole user specific field 1 occupies 88 bits and each user field or each 1st portion of UEM user field sequentially occupies 22 bits. By blindly scanning the user specific field 1, a user will find its user field or 1st portion of its UEM user field by its STA-ID, and be aware of the order of its user field or its 1st UEM user field portion in the User Specific field 1, which help the user identify the position of its RU. Also, in a user's user field or 1st portion of its UEM user field, the user will know if it is an unequal MCS user from an indication in the 1st UEM user field portion. If yes, the user also needs to look for the remaining portions of its UEM user field in the User Specific field 2. For example, by blindly scanning User Specific field 1, user 1 found the 1st portion of its UEM user field is the first one in User Specific field 1. As a result, it will know its RU is also the first one in all RUs. Meanwhile, user 1 will be informed that it is an unequal MCS user, so the user must search other portions of its UEM user field in the user specific field 2 to obtain its MCS information.

Formats of user fields and UEM user fields vary based on approaches that how a user identifies itself as a non-unequal or an unequal MCS user and how to obtain its MCS information. Considering compatibility and overhead, three designs are proposed for user fields and UEM user fields, including:
1) Unequal MCS users are indicated by EHT-MCS 14 in the user specific field 1, and UEM user field portions in the user specific field 2 are identified by STA-ID;
2) Unequal MCS users are indicated by EHT-MCS 14 in the user specific field 1, and the user specific field 1 provides the position information of the remaining portions of the UEM user field in User Specific field 2.
3) Unequal MCS users are indicated by an indication other than EHT-MCS 14, and the User Specific field 1 provides the position information of UEM user field portions in User Specific field 2. The length of different portions of the UEM user field can be different.

The technical details of these three approaches and corresponding designs are elaborated by examples as follows.

In one or more embodiments, an unequal MCS system may facilitate in Approach 1 unequal MCS users indicated by EHT-MCS 14 in the user specific field 1 and UEM user field portions in the user specific field 2 identified by STA-ID

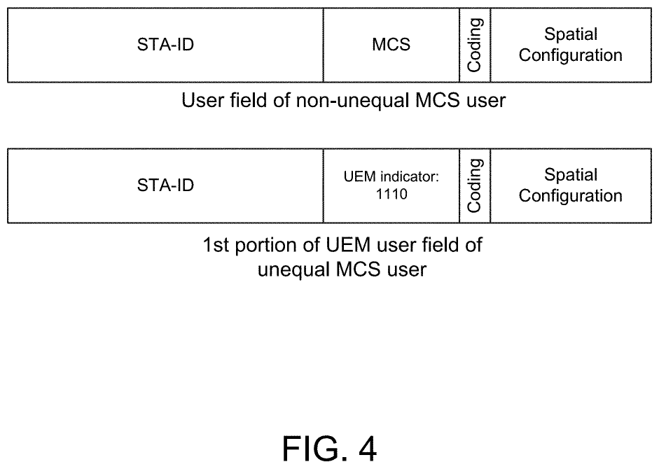

In approach 1, the formats of user fields and 1st portion of UEM user fields are shown in FIG. 4. FIG. 4 shows the User field and 1st portion of the UEM user field in approach 1.

If a user is a non-unequal MCS user, its user field is as same as the traditional user field in EHT specification of the IEEE standard, which carries the information of STA-ID, MCS, coding and spatial configuration. However, for an unequal MCS user, the 1st portion of its UEM user field includes subfields of STA-ID, an indicator of unequal MCS (UEM) users (EHT-MCS 14: 1110), coding, and spatial configuration. EHT-MCS 14 (1110) could be used as a UEM indicator, as EHT-MCS 14 (1110) is only utilized in EHT DUP transmission mode, when PPDU Type and Compression Mode subfield in U-SIG is set to 1, indicating EHT Single User (SU) transmission. Thus, when PPDU Type and Compression Mode is 0 or 2 (NOT EHT SU transmission), EHT-MCS 14 (1110) is used to indicate unequal MCS users. Moreover, if it is EHT SU transmission meanwhile unequal MCS user, PPDU Type and Compression Mode subfield is set to be 4 and EHT-MCS 14 (1110) is still used as an indicator of unequal MCS user. Table 1 sums up the mapping from subfields to unequal MCS user types.

TABLE 1
unequal MCS user indicator

| Subfield | Unequal MCS user type |
|---|---|
| PPDU Type and Compression Mode | Unequal MCS user under DL |
| subfield 0/2 + EHT-MCS 14 (1110) | OFDMA/non-OFDMA DL MU- |
| | MIMO |
| PPDU Type and Compression Mode | DUP Transmission |
| subfield 1 + EHT-MCS 14 (1110) | |
| PPDU Type and Compression Mode | Unequal MCS user under SU |
| subfield 4 + EHT-MCS 14 (1110) | transmission |

A user identifies its user field/1 st portion of its UEM user field through STA-ID and knows if it is an unequal MCS user through the UEM indicator. Also, through spatial configuration, an unequal MCS user will be aware of the number of its spatial streams. As different spatial streams are allocated with different MCSs, it also learns how many MCSs the user needs to obtain from non-first portions of its UEM user field in the user specific field 2.

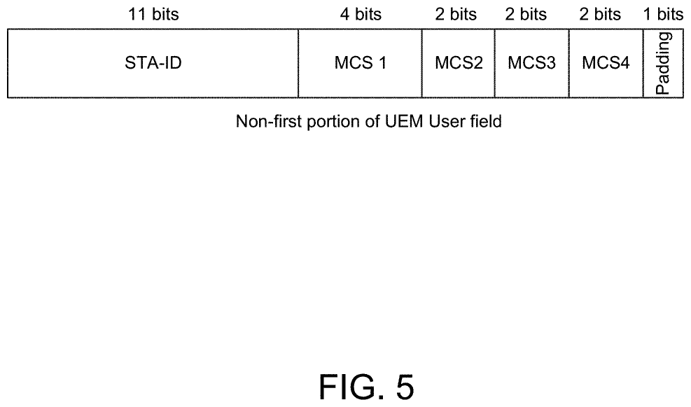

In approach 1, the format of other portions (non-first) of a UEM user field in the user specific field 2 is simple, as it only needs to provide STA-ID to let unequal MCS users identify their UEM user field portions and obtain MCS information. To make users aware of the start and end of UEM user field portions, the length of a non-first UEM user field portion should be fixed. FIG. 5 shows a non-first portion of a UEM user field in the user specific field 2 with 1 STA-ID and 4 MCS subfields in each UEM user field portion, the length of which is the same as the user field and the first portion of a UEM user field, 22 bits, for easy implementation. If the MCSs of a user are less than 4, unused MCS subfields in the non-first UEM user field portion will be padded. On the contrary, if a user has more than 4 MCSs, for example, 8 MCSs, 2 non-first UEM user field portions with the same STA-ID will be assigned to this user, each of which provides 4 MCSs for it. As an unequal MCS user is aware of the number of its MCSs from its user field, this user will keep searching its UEM user field portions until obtaining all its MCSs.

FIG. 5 shows a non-first portion of the UEM user field in approach 1 when unequal MCSs share the same coding rate. In a non-first portion of the UEM user field of FIG. 5, the first MCS subfield, MCS 1, is a 4-bit binary number, indicating the MCS index with the largest modulation order of the user. To reduce overhead, the remaining MCS subfields are 2-bit binary numbers, indicating modulation order deduction compared to the previous MCS, rather than the MCS index. An example is given by the following Table which is from the current EHT PHY specifications. If MCS 1 is 1011 (Index 10), representing 1024-QAM with 3/4 coding rate, and MCS 2 is 10, indicating three modulation order lower than MCS 1, MCS 2 is 16-QAM 3/4, where 16-QAM is three modulation order lower than 1024-QAM. If more than 4 MCSs are assigned to a user, its MCSs appear in the order of from the largest modulation to the lowest modulation. For example, a user has 6 spatial streams with 6 MCSs. MCSs 1 to 4 of the second portion of its UEM user field are utilized to deliver MCSs with the largest modulation, the second largest modulation, the third largest modulation, and the fourth largest modulation, respectively. MCS 1 and MCS 2 of the third portion of its UEM user field convey MCSs with the second to lowest modulation and with the lowest modulation, respectively. In this way, 2 adjacent MCS subfields in a UEM user field will have a relatively small modulation order difference.

The UEM user field design in FIG. 5 is applicable depending on an important condition. To be specific, the used unequal MCS method follows the current EHT PHY specifications that unequal MCSs of a user share the same coding rate and only modulations are different. As the modulation difference between 2 adjacent MCS subfields is generally less than 4 modulation order in practice. Therefore, only 2 bits is adequate to indicate modulation order deduction compared to the previous MCS.

TABLE 36-71
EHT-MCSs for 26-tone RU, N_{SS,u} = 1

| EHT- | | | | | | | Data rate (Mb/s) | | |
|---|---|---|---|---|---|---|---|---|---|
| MCS | | | | | | | 0.8 μs | 1.6 μs | 3.2 μs |
| index | Modulation | Rᵤ | N_{BPSCS,u} | N_{SD,u} | N_{CBPS,u} | N_{DBPS,u} | GI | GI | GI |
| 0 | BPSK | ½ | 1 | 24 | 24 | 12 | 0.9 | 0.8 | 0.8 |
| 1 | QPSK | ½ | 2 | | 48 | 24 | 1.8 | 1.7 | 1.5 |
| 2 | | ¾ | | | | 36 | 2.6 | 2.5 | 2.3 |
| 3 | 16-QAM | ½ | 4 | | 96 | 48 | 3.5 | 3.3 | 3.0 |
| 4 | | ¾ | | | | 72 | 5.3 | 5.0 | 4.5 |
| 5 | 64-QAM | ⅔ | 6 | | 144 | 96 | 7.1 | 6.7 | 6.0 |
| 6 | | ¾ | | | | 108 | 7.9 | 7.5 | 6.8 |
| 7 | | ⅚ | | | | 120 | 3.8 | 8.3 | 7.5 |
| 8 | 256-QAM | ¾ | 8 | | 192 | 144 | 10.6 | 10.0 | 9.0 |
| 9 | | ⅚ | | | | 160 | 11.8 | 11.1 | 10.0 |
| 10 | 1024-QAM | ¾ | 10 | | 240 | 180 | 13.2 | 12.5 | 11.3 |
| 11 | | ⅚ | | | | 200 | 14.7 | 13.9 | 12.5 |
| 12 | 4096-QAM | ¾ | 12 | | 288 | 216 | 15.9 | 15.0 | 13.5 |
| 13 | | ⅚ | | | | 240 | 17.6 | 16.7 | 15.0 |
| 15 | BPSK-DCM | ½ | 1 | 12 | 12 | 6 | 0.4 | 0.4 | 0.4 |

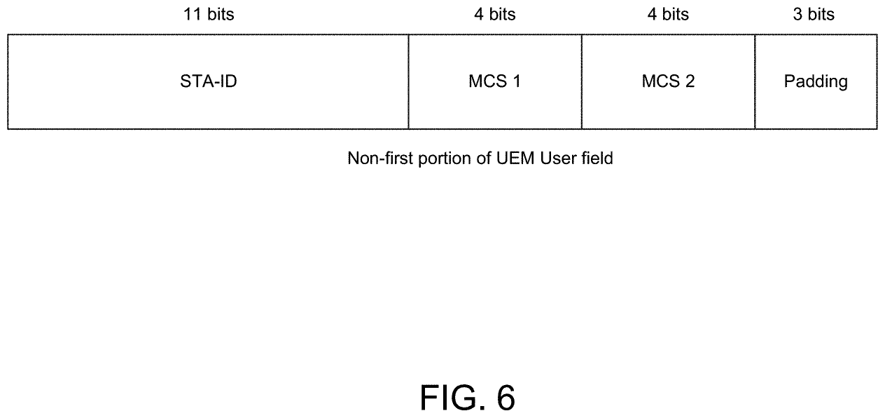

However, if both modulations and coding rates are different in unequal MCSs, 2 bits are not enough to present the difference of both modulation and coding between two adjacent MCS subfields. Instead, all MCS subfields should use 4 bits to indicate the MCS index like MCS 1, bringing in more overhead, as shown in FIG. 6. FIG. 6 shows a non-first portion of the UEM user field in approach 1 when unequal MCSs do not share the same coding rate. In this case, an unequal MCS user could be assigned with up to 4 non-first portions per UEM user field, when this user has 7 or 8 spatial streams and MCSs.

In one or more embodiments, an unequal MCS system may facilitate in Approach 2, unequal MCS users that are indicated by EHT-MCS 14 in the user specific field 1 and the position information of UEM user field portions in User Specific field 2 provided in the User Specific field 1.

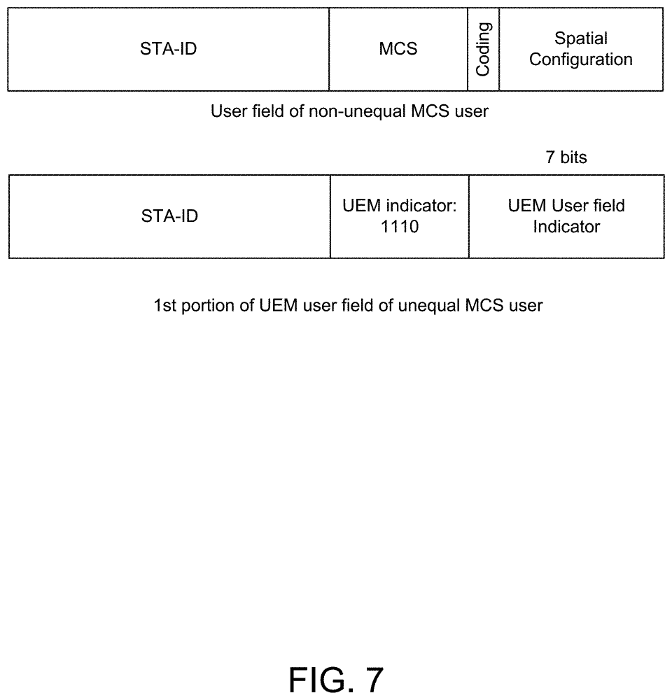

In one embodiment, this approach uses the last 7 bits of an unequal MCS user's 1st portion of UEM user field to indicate the position of this user's other UEM user field portions in the user specific field 2. The last 7 bit field may be named UEM user field indicator subfield. The format of the 1st UEM user field portion is shown as FIG. 7. FIG. 7, shows a user field and 1st portion of the UEM user field in approach 2. The length of the 1st UEM user field portion is still fixed (22 bits), aligning with the current EHT PHY specifications to allow a user to blindly scan User Specific field 1 to find its own user field/1st UEM user field portion. By checking UEM user field indicator subfield, unequal MCS users will be notified of the positions of other portions of their UEM user fields in the User Specific field 2. For non-unequal MCS users, their user field may be the same as the conventional user field in the current EHT PHY specification. With respect to FIG. 3, the UEM User field indicator may specify a non-negative number, the number of users together which specifies the position of the 2^{nd} portion of the UEM user. For example, the non-negative number n=0 specifies that the first portion after K user fields/1^{st} portions. In other words, the position of the 2^{nd} portion is the (K+n+1)-th unit, where one unit is a user field or a portion. The 3^{rd} and latter portions of the same UEM user may be immediately after the 2^{nd} so that there is no need to indicate their positions in the 1^{st} and 2^{nd} portions.

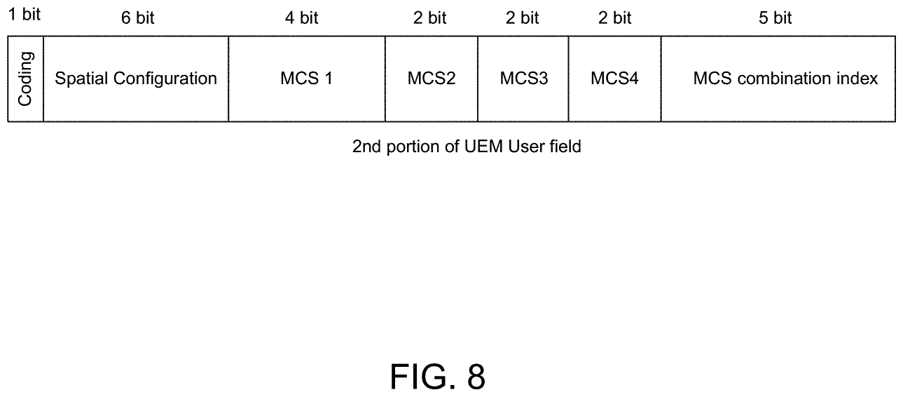

FIG. 8 shows the format of a 2nd UEM user field portion in Approach 2, which consists of coding and spatial configuration subfields, originally included in user fields and MCS subfields. FIG. 8 shows the 2nd portion of the UEM User field in Approach 2 when unequal MCSs share the same coding rate. Still, the length of a 2nd UEM user field portion can be 22 bits, the same as the user field and the 1st UEM user field portion, for easy implementation. Moreover, the unequal MCSs of the same user may share the same coding rate and only the modulation orders vary for different spatial streams. MCSs in a 2nd UEM user field portion appear in the order from the largest modulation to the lowest modulation. Like approach 1, MCS 1, is a 4-bit binary number, indicating the index of the MCS with the largest modulation, while the next 3 MCS subfields are 2-bit binary number, indicating modulation order deduction compared to its previous MCS subfield. The last 5 bits are used to indicate the rest of the MCSs if the number of spatial streams/MCSs is more than 4. Namely, some largest modulation orders are specified individually, and the rest are specified jointly using a lookup table defined in the IEEE 802.11 Standard. In the EHT PHY specification, there are totally 8 modulations. After 4 MCS subfields, the last 5 bits are used to index the combinations of maximumly 4 modulations. Apparently, 5 bits is enough to cover all possible combinations of 4 modulations. Therefore, one 2nd UEM user field portion in approach 2 is capable of handling 8 MCSs, the maximum number of spatial streams/MCSs that could be assigned to a user.

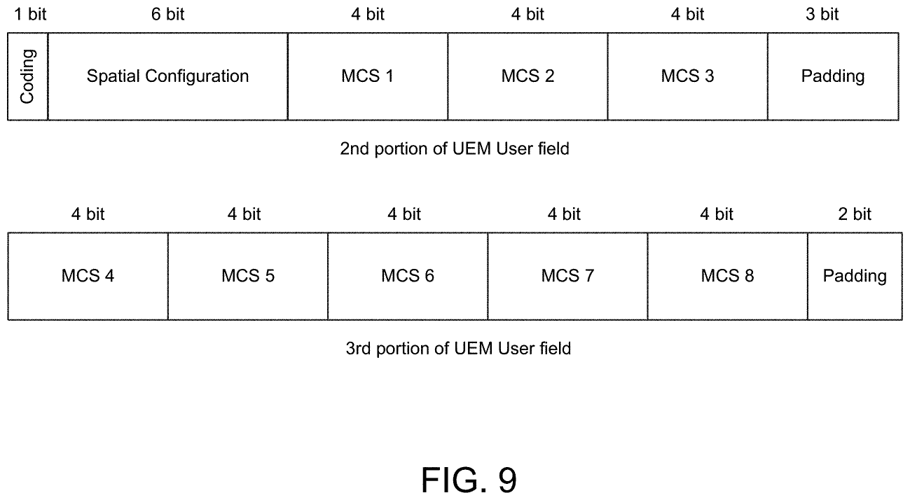

Another situation should be considered that both modulations and coding rates are different in unequal MCSs. Namely, different spatial streams can have different modulation orders and different coding rates, respectively. In this case, 2 bits are not enough to present the difference between both modulation and coding, and 4 bits are contained in each MCS subfield, expressing the MCS index. FIG. 9 shows the format of the 2nd and 3rd portion of the UEM User field when unequal MCSs are different in both modulation and coding (do not share the same coding rate). If a user has 3 MCSs or less, only the 2nd UEM user field portion will be assigned to this user, otherwise, the 3rd UEM user field portion is needed. Note that the UEM user field indicator subfield in the 1st portion of the UEM user field only indicates the position of the 2nd UEM user field portion. Thus, the 3rd UEM user field portion of a user is always next to its 2nd one, so that the user will know the position of its 3rd UEM user field portion based on its 2nd portion. The 2nd and 3rd UEM user field portions may be included in the same UEM user encoding block or in the adjacent UEM user encoding blocks subsequently. If in the same UEM user encoding block, the user will decode this block and get its both 2nd and 3rd UEM user field portions. If in the adjacent UEM user encoding blocks, the user needs to decode both these two UEM user encoding blocks. After decoding the 2nd UEM user field portion, the user will know the number of its spatial streams/MCSs through the spatial configuration subfield, which determines if all this user's MCSs can be obtained just by decoding the current UEM user encoding block. If not, the user has to decode the next UEM user encoding block to obtain its 3rd UEM user field portion to get the rest of the MCSs. Since the modulation order usually monotonically decreases with the spatial stream index, the number of MCS indication bits for stream 2 and greater can be 3 or less instead of 4 as shown in FIG. 9.

In one or more embodiments, an unequal MCS system may facilitate in Approach 3, unequal MCS users that are indicated by other additional bits and the position information of UEM user field portions in User Specific field 2 provided by the User Specific field 1.

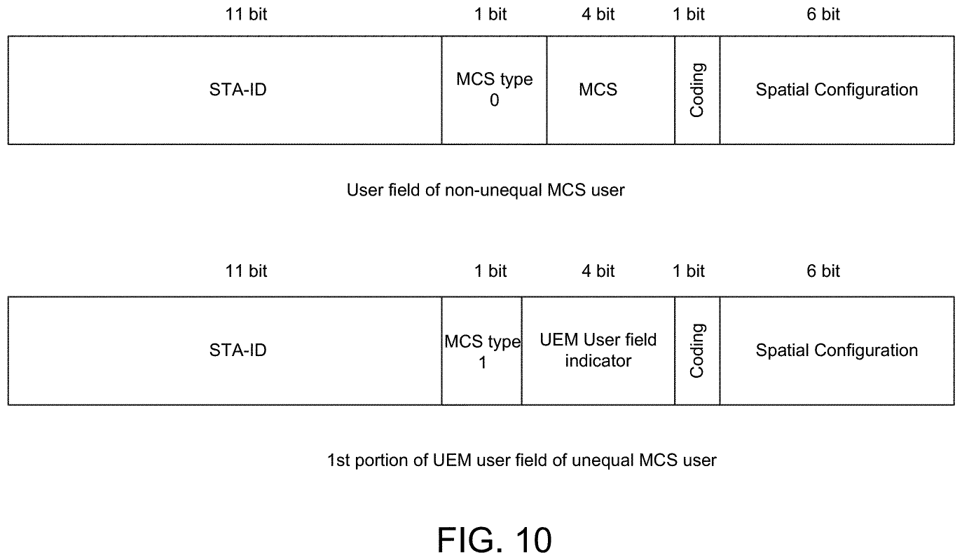

In Approach 1 and Approach 2, each designed user field and each UEM user field's first portion have 22 bits the same as the current EHT PHY specification, to be compatible with Wi-Fi 7. In the future Wi-Fi 8, the length of them may be open to change. Thus, in Approach 3, new user fields and UEM user field portions are designed, the length of which is not 22 bits anymore. FIG. 10 presents user fields of non-unequal MCS users and 1st UEM user field portions of unequal MCS users, where a new subfield, MCS type, is originally defined with the size of 1 bit. Therefore, the length of user fields and 1st UEM user field portions become 23 bits. MCS type is set to 1 to indicate an unequal MCS user, otherwise 0. When MCS type is 0, the next 4 bits is the MCS subfield, providing the index of MCS used by this non-unequal MCS user. When it is 1, the next 4 bits is a UEM user field indicator subfield, informing the unequal MCS user of the position of its 2nd UEM user field portion. For example, if a UEM user field indicator subfield carries 0101, the unequal MCS user will know its 2nd UEM user field portion is the 5th UEM user field portion in the user specific field 2. An unequal MCS user can have up to 2 non-first UEM user field portions. If the unequal MCS has 2 non-first UEM user field portions, its 2nd and 3rd portions would be 5-th and 6-th UEM user field portions in the user specific field 2.

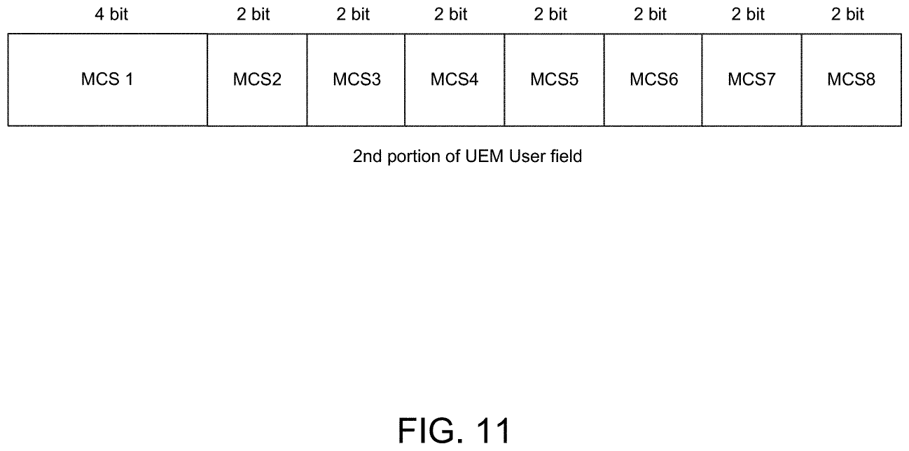

For non-first portions of the UEM User field, each of them has 18 bits, less than 22 bits of user field in the current specification. As an unequal MCS user has already known the position of its 2nd UEM User field portion through the UEM user field indicator subfield in its 1st UEM User field portion, the 2nd UEM User field portion only needs to include MCS information with less bits. FIG. 11 shows the 2nd UEM User field portion in approach 3 when unequal MCSs share the same coding rate. MCS 1, is a 4-bit binary number, indicating the index of the MCS with the largest modulation, while the following MCS subfields are 2-bit binary number, indicating modulation order deduction compared to its previous MCS subfield. MCSs are ranked in the order of from largest modulation to lowest modulation.

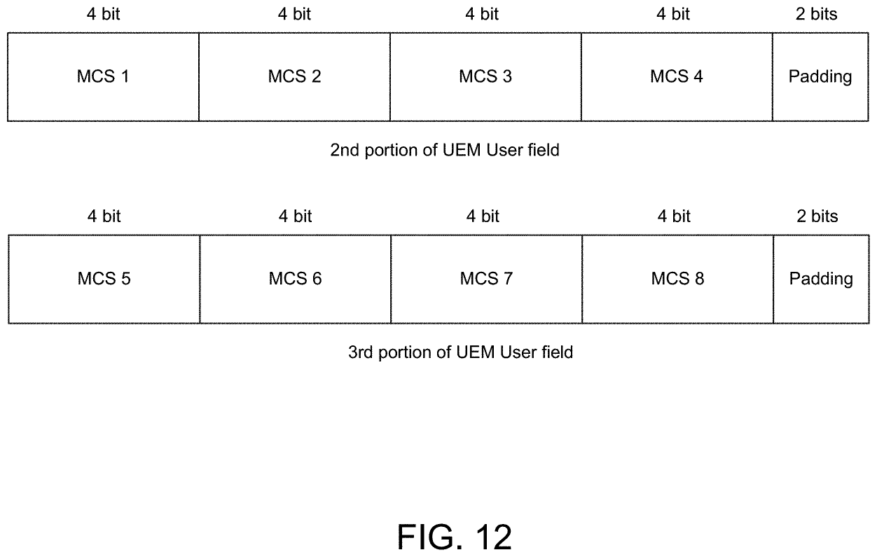

FIG. 12 presents 2nd and 3rd UEM User field portions in Approach 3 when unequal MCSs are different in both modulation and coding (do not share the same coding rate), where 4 MCS subfields are involved in a 2nd/3rd UEM user field portion. In this case, each MCS subfield has 4 bits, indicating the index of MCSs. If an unequal MCS user has more than 4 MCSs, 2 non-first UEM user field portions will be assigned to this user. Its 3rd UEM user field portion always follows its 2nd UEM user field portion, so that UEM user field indicator subfields are only required to provide the position of the 2nd UEM user field portion, while the position of the 3rd one would be automatically known.

It is understood that the above descriptions are for purposes of illustration and are not meant to be limiting.

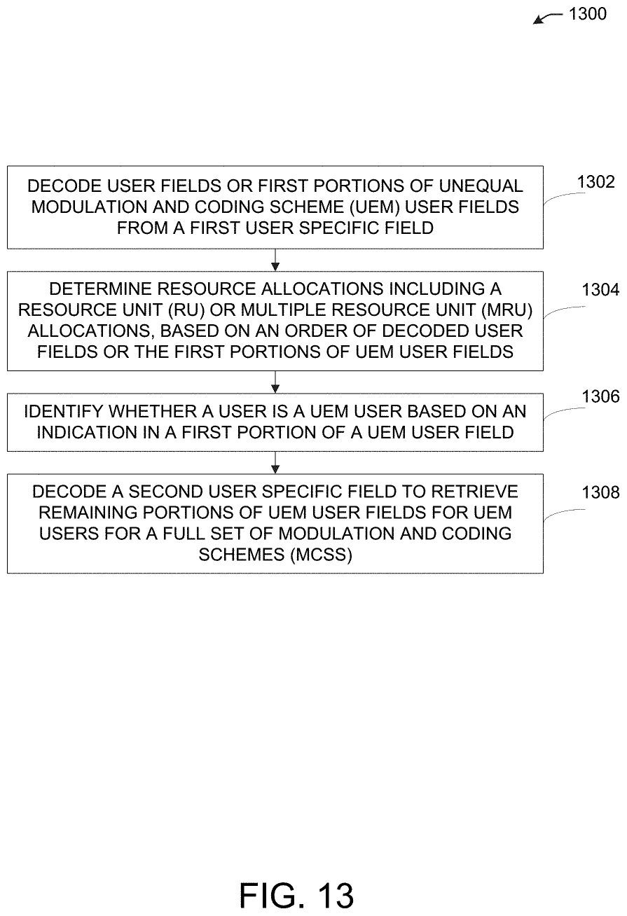

FIG. 13 illustrates a flow diagram of a process 1300 for an unequal MCS system, in accordance with one or more example embodiments of the present disclosure.

At block 1302, a device (e.g., the user device(s) 120 and/or the AP 102 of FIG. 1 and/or the unequal MCS device 1519 of FIG. 15) may decode user fields or first portions of unequal modulation and coding scheme (UEM) user fields from a first user specific field.

At block 1304, the device may determine resource allocations including a resource unit (RU) or multiple resource unit (MRU) allocations, based on an order of decoded user fields or the first portions of UEM user fields.

At block 1306, the device may identify whether a user is a UEM user based on an indication in a first portion of a UEM user field.

At block 1306, the device may decode a second user specific field to retrieve the remaining portions of UEM user fields for UEM users for a full set of modulation and coding schemes (MCSs).

In the process illustrated in FIG. 13, the device starts by decoding user fields or first portions of unequal modulation and coding scheme (UEM) user fields from a first user specific field. It then identifies UEM users by decoding an extremely high throughput MCS 14 (EHT-MCS 14) indication carried by MCS subfields of the first portion of UEM user fields in the first user specific field.

The device May locate the remaining portions of UEM user fields in the second user specific field by blindly scanning an identified station identification (STA-ID). Following this, it scans the first user specific field to find a user's user field or a first portion of its UEM user field based on its station identification (ID).

It is important to note that a user's remaining portions of UEM user fields are always adjacent to each other in the second user specific field. The device then identifies a position of a user's resource unit or multiple resource units (RU or MRU) based on the order of its user field or its first UEM user field portion in the first user specific field.

The process would involve decoding UEM user field portions in the second user specific field using an identified station identification (STA-ID). The first user specific field and the second user specific field are then decoded sequentially, with the second user specific field providing the remaining portions of a UEM user field.

The device may also utilize multiple-input multiple-output (MIMO) technology to increase a capacity of wireless transmissions by assigning different MCS values to different spatial streams for UEM users. Furthermore, the device adaptively assigns multiple MCSs for a UEM user based on channel conditions, interference, and user requirements of its spatial streams.

Lastly, it should be observed that a user field and each portion of UEM user fields may have the same length and the same number of bits in the process depicted in FIG. 13.

It is understood that the above descriptions are for purposes of illustration and are not meant to be limiting.

FIG. 14 shows a functional diagram of an exemplary communication station 1400, in accordance with one or more example embodiments of the present disclosure. In one embodiment, FIG. 14 illustrates a functional block diagram of a communication station that may be suitable for use as an AP 102 (FIG. 1) or a user device 120 (FIG. 1) in accordance with some embodiments. The communication station 1400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1400 may include communications circuitry 1402 and a transceiver 1410 for transmitting and receiving signals to and from other communication stations using one or more antennas 1401. The communications circuitry 1402 may include circuitry that can operate the physical layer (PHY) communications and/or medium access control (MAC) communications for controlling access to the wireless medium, and/or any other communications layers for transmitting and receiving signals. The communication station 1400 may also include processing circuitry 1406 and memory 1408 arranged to perform the operations described herein. In some embodiments, the communications circuitry 1402 and the processing circuitry 1406 may be configured to perform operations detailed in the above figures, diagrams, and flows.

In accordance with some embodiments, the communications circuitry 1402 may be arranged to contend for a wireless medium and configure frames or packets for communicating over the wireless medium. The communications circuitry 1402 may be arranged to transmit and receive signals. The communications circuitry 1402 may also include circuitry for modulation/demodulation, upconversion/downconversion, filtering, amplification, etc. In some embodiments, the processing circuitry 1406 of the communication station 1400 may include one or more processors. In other embodiments, two or more antennas 1401 may be coupled to the communications circuitry 1402 arranged for sending and receiving signals. The memory 1408 may store information for configuring the processing circuitry 1406 to perform operations for configuring and transmitting message frames and performing the various operations described herein. The memory 1408 may include any type of memory, including non-transitory memory, for storing information in a form readable by a machine (e.g., a computer). For example, the memory 1408 may include a computer-readable storage device, read-only memory (ROM), random-access memory (RAM), magnetic disk storage media, optical storage media, flash-memory devices and other storage devices and media.

In some embodiments, the communication station 1400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1400 may include one or more antennas 1401. The antennas 1401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1400 may include one or more of a keyboard, a display, a non-volatile memory port, multiple antennas, a graphics processor, an application processor, speakers, and other mobile device elements. The display may be an LCD screen including a touch screen.

Although the communication station 1400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1400 may include one or more processors and may be configured with instructions stored on a computer-readable storage device.

FIG. 15 illustrates a block diagram of an example of a machine 1500 or system upon which any one or more of the techniques (e.g., methodologies) discussed herein may be performed. In other embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environments. The machine 1500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1500 may include a hardware processor 1502 (e.g., a central processing unit (CPU), a graphics processing unit (GPU), a hardware processor core, or any combination thereof), a main memory 1504 and a static memory 1506, some or all of which may communicate with each other via an interlink (e.g., bus) 1508. The machine 1500 may further include a power management device 1532, a graphics display device 1510, an alphanumeric input device 1512 (e.g., a keyboard), and a user interface (UI) navigation device 1514 (e.g., a mouse). In an example, the graphics display device 1510, alphanumeric input device 1512, and UI navigation device 1514 may be a touch screen display. The machine 1500 may additionally include a storage device (i.e., drive unit) 1516, a signal generation device 1518 (e.g., a speaker), an unequal MCS device 1519, a network interface device/transceiver 1520 coupled to antenna(s) 1530, and one or more sensors 1528, such as a global positioning system (GPS) sensor, a compass, an accelerometer, or other sensor. The machine 1500 may include an output controller 1534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1502 for generation and processing of the baseband signals and for controlling operations of the main memory 1504, the storage device 1516, and/or the unequal MCS device 1519. The baseband processor may be provided on a single radio card, a single chip, or an integrated circuit (IC).

The storage device 1516 may include a machine readable medium 1522 on which is stored one or more sets of data structures or instructions 1524 (e.g., software) embodying or utilized by any one or more of the techniques or functions described herein. The instructions 1524 may also reside, completely or at least partially, within the main memory 1504, within the static memory 1506, or within the hardware processor 1502 during execution thereof by the machine 1500. In an example, one or any combination of the hardware processor 1502, the main memory 1504, the static memory 1506, or the storage device 1516 may constitute machine-readable media.

The unequal MCS device 1519 may carry out or perform any of the operations and processes (e.g., process 1300) described and shown above.

It is understood that the above are only a subset of what the unequal MCS device 1519 may be configured to perform and that other functions included throughout this disclosure may also be performed by the unequal MCS device 1519.

While the machine-readable medium 1522 is illustrated as a single medium, the term “machine-readable medium” may include a single medium or multiple media (e.g., a centralized or distributed database, and/or associated caches and servers) configured to store the one or more instructions 1524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1500 and that cause the machine 1500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device/transceiver 1520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1520 may include one or more physical jacks (e.g., Ethernet, coaxial, or phone jacks) or one or more antennas to connect to the communications network 1526. In an example, the network interface device/transceiver 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

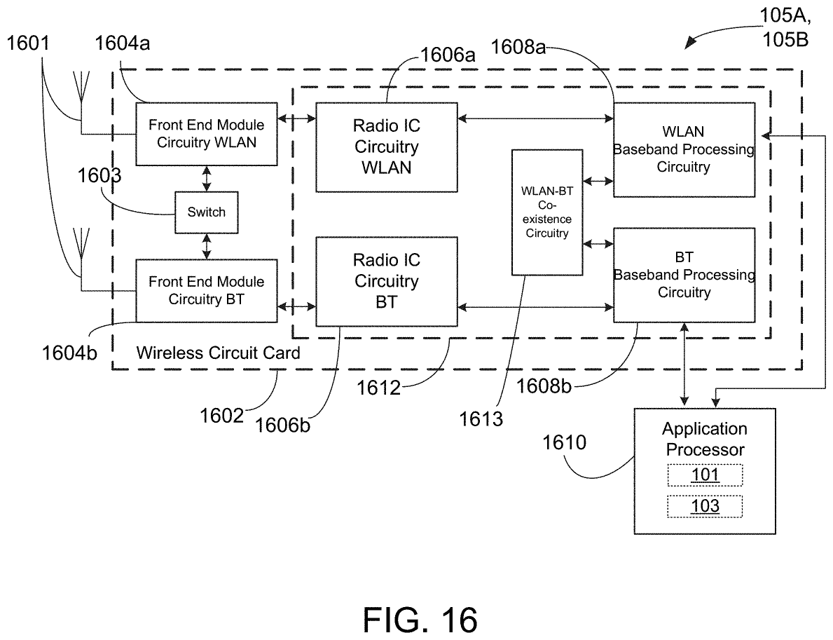

FIG. 16 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1604a-b, radio IC circuitry 1606a-b and baseband processing circuitry 1608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1604a-b may include a WLAN or Wi-Fi FEM circuitry 1604a and a Bluetooth (BT) FEM circuitry 1604b. The WLAN FEM circuitry 1604a may include a receive signal path comprising circuitry configured to operate on WLAN RF signals received from one or more antennas 1601, to amplify the received signals and to provide the amplified versions of the received signals to the WLAN radio IC circuitry 1606a for further processing. The BT FEM circuitry 1604b may include a receive signal path which may include circuitry configured to operate on BT RF signals received from one or more antennas 1601, to amplify the received signals and to provide the amplified versions of the received signals to the BT radio IC circuitry 1606b for further processing. FEM circuitry 1604a may also include a transmit signal path which may include circuitry configured to amplify WLAN signals provided by the radio IC circuitry 1606a for wireless transmission by one or more of the antennas 1601. In addition, FEM circuitry 1604b may also include a transmit signal path which may include circuitry configured to amplify BT signals provided by the radio IC circuitry 1606b for wireless transmission by the one or more antennas. In the embodiment of FIG. 16, although FEM 1604a and FEM 1604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1606a-b as shown may include WLAN radio IC circuitry 1606a and BT radio IC circuitry 1606b. The WLAN radio IC circuitry 1606a may include a receive signal path which may include circuitry to down-convert WLAN RF signals received from the FEM circuitry 1604a and provide baseband signals to WLAN baseband processing circuitry 1608a. BT radio IC circuitry 1606b may in turn include a receive signal path which may include circuitry to down-convert BT RF signals received from the FEM circuitry 1604b and provide baseband signals to BT baseband processing circuitry 1608b. WLAN radio IC circuitry 1606a may also include a transmit signal path which may include circuitry to up-convert WLAN baseband signals provided by the WLAN baseband processing circuitry 1608a and provide WLAN RF output signals to the FEM circuitry 1604a for subsequent wireless transmission by the one or more antennas 1601. BT radio IC circuitry 1606b may also include a transmit signal path which may include circuitry to up-convert BT baseband signals provided by the BT baseband processing circuitry 1608b and provide BT RF output signals to the FEM circuitry 1604b for subsequent wireless transmission by the one or more antennas 1601. In the embodiment of FIG. 16, although radio IC circuitries 1606a and 1606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1608a-b may include a WLAN baseband processing circuitry 1608a and a BT baseband processing circuitry 1608b. The WLAN baseband processing circuitry 1608a may include a memory, such as, for example, a set of RAM arrays in a Fast Fourier Transform or Inverse Fast Fourier Transform block (not shown) of the WLAN baseband processing circuitry 1608a. Each of the WLAN baseband circuitry 1608a and the BT baseband circuitry 1608b may further include one or more processors and control logic to process the signals received from the corresponding WLAN or BT receive signal path of the radio IC circuitry 1606a-b, and to also generate corresponding WLAN or BT baseband signals for the transmit signal path of the radio IC circuitry 1606a-b. Each of the baseband processing circuitries 1608a and 1608b may further include physical layer (PHY) and medium access control layer (MAC) circuitry, and may further interface with a device for generation and processing of the baseband signals and for controlling operations of the radio IC circuitry 1606a-b.

Referring still to FIG. 16, according to the shown embodiment, WLAN-BT coexistence circuitry 1613 may include logic providing an interface between the WLAN baseband circuitry 1608a and the BT baseband circuitry 1608b to enable use cases requiring WLAN and BT coexistence. In addition, a switch 1603 may be provided between the WLAN FEM circuitry 1604a and the BT FEM circuitry 1604b to allow switching between the WLAN and BT radios according to application needs. In addition, although the antennas 1601 are depicted as being respectively connected to the WLAN FEM circuitry 1604a and the BT FEM circuitry 1604b, embodiments include within their scope the sharing of one or more antennas as between the WLAN and BT FEMs, or the provision of more than one antenna connected to each of FEM 1604a or 1604b.

In some embodiments, the front-end module circuitry 1604a-b, the radio IC circuitry 1606a-b, and baseband processing circuitry 1608a-b may be provided on a single radio card, such as wireless radio card 1602. In some other embodiments, the one or more antennas 1601, the FEM circuitry 1604a-b and the radio IC circuitry 1606a-b may be provided on a single radio card. In some other embodiments, the radio IC circuitry 1606a-b and the baseband processing circuitry 1608a-b may be provided on a single chip or integrated circuit (IC), such as IC 1612.

In some embodiments, the wireless radio card 1602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., SGPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

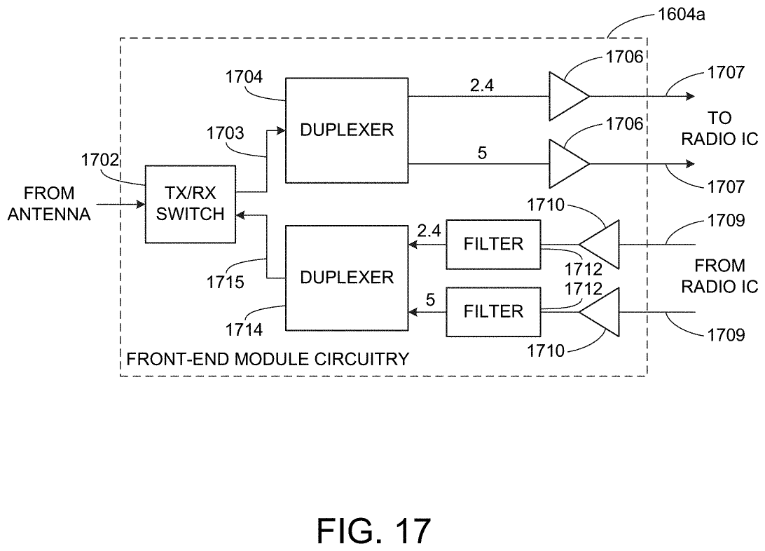

FIG. 17 illustrates WLAN FEM circuitry 1604a in accordance with some embodiments. Although the example of FIG. 17 is described in conjunction with the WLAN FEM circuitry 1604a, the example of FIG. 17 may be described in conjunction with the example BT FEM circuitry 1604b (FIG. 16), although other circuitry configurations may also be suitable.

In some embodiments, the FEM circuitry 1604a may include a TX/RX switch 1702 to switch between transmit mode and receive mode operation. The FEM circuitry 1604a may include a receive signal path and a transmit signal path. The receive signal path of the FEM circuitry 1604a may include a low-noise amplifier (LNA) 1706 to amplify received RF signals 1703 and provide the amplified received RF signals 1707 as an output (e.g., to the radio IC circuitry 1606a-b (FIG. 16)). The transmit signal path of the circuitry 1604a may include a power amplifier (PA) to amplify input RF signals 1709 (e.g., provided by the radio IC circuitry 1606a-b), and one or more filters 1712, such as band-pass filters (BPFs), low-pass filters (LPFs) or other types of filters, to generate RF signals 1715 for subsequent transmission (e.g., by one or more of the antennas 1601 (FIG. 16)) via an example duplexer 1714.

In some dual-mode embodiments for Wi-Fi communication, the FEM circuitry 1604a may be configured to operate in either the 2.4 GHz frequency spectrum or the 5 GHz frequency spectrum. In these embodiments, the receive signal path of the FEM circuitry 1604a may include a receive signal path duplexer 1704 to separate the signals from each spectrum as well as provide a separate LNA 1706 for each spectrum as shown. In these embodiments, the transmit signal path of the FEM circuitry 1604a may also include a power amplifier 1710 and a filter 1712, such as a BPF, an LPF or another type of filter for each frequency spectrum and a transmit signal path duplexer 1704 to provide the signals of one of the different spectrums onto a single transmit path for subsequent transmission by the one or more of the antennas 1601 (FIG. 16). In some embodiments, BT communications may utilize the 2.4 GHz signal paths and may utilize the same FEM circuitry 1604a as the one used for WLAN communications.

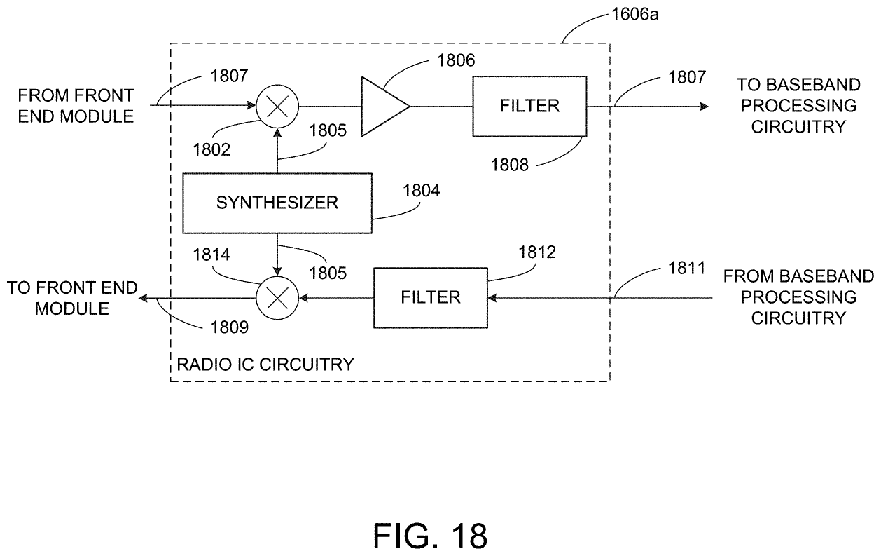

FIG. 18 illustrates radio IC circuitry 1606a in accordance with some embodiments. The radio IC circuitry 1606a is one example of circuitry that may be suitable for use as the WLAN or BT radio IC circuitry 1606a/1606b (FIG. 16), although other circuitry configurations may also be suitable. Alternatively, the example of FIG. 18 may be described in conjunction with the example BT radio IC circuitry 1606b.

In some embodiments, the radio IC circuitry 1606a may include a receive signal path and a transmit signal path. The receive signal path of the radio IC circuitry 1606a may include at least mixer circuitry 1802, such as, for example, down-conversion mixer circuitry, amplifier circuitry 1806 and filter circuitry 1808. The transmit signal path of the radio IC circuitry 1606a may include at least filter circuitry 1812 and mixer circuitry 1814, such as, for example, up-conversion mixer circuitry. Radio IC circuitry 1606a may also include synthesizer circuitry 1804 for synthesizing a frequency 1805 for use by the mixer circuitry 1802 and the mixer circuitry 1814. The mixer circuitry 1802 and/or 1814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 18 illustrates only a simplified version of a radio IC circuitry, and may include, although not shown, embodiments where each of the depicted circuitries may include more than one component. For instance, mixer circuitry 1814 may each include one or more mixers, and filter circuitries 1808 and/or 1812 may each include one or more filters, such as one or more BPFs and/or LPFs according to application needs. For example, when mixer circuitries are of the direct-conversion type, they may each include two or more mixers.

In some embodiments, mixer circuitry 1802 may be configured to down-convert RF signals 1707 received from the FEM circuitry 1604a-b (FIG. 16) based on the synthesized frequency 1805 provided by synthesizer circuitry 1804. The amplifier circuitry 1806 may be configured to amplify the down-converted signals and the filter circuitry 1808 may include an LPF configured to remove unwanted signals from the down-converted signals to generate output baseband signals 1807. Output baseband signals 1807 may be provided to the baseband processing circuitry 1608a-b (FIG. 16) for further processing. In some embodiments, the output baseband signals 1807 may be zero-frequency baseband signals, although this is not a requirement. In some embodiments, mixer circuitry 1802 may comprise passive mixers, although the scope of the embodiments is not limited in this respect.

In some embodiments, the mixer circuitry 1814 may be configured to up-convert input baseband signals 1811 based on the synthesized frequency 1805 provided by the synthesizer circuitry 1804 to generate RF output signals 1709 for the FEM circuitry 1604a-b. The baseband signals 1811 may be provided by the baseband processing circuitry 1608a-b and may be filtered by filter circuitry 1812. The filter circuitry 1812 may include an LPF or a BPF, although the scope of the embodiments is not limited in this respect.

In some embodiments, the mixer circuitry 1802 and the mixer circuitry 1814 may each include two or more mixers and may be arranged for quadrature down-conversion and/or up-conversion respectively with the help of synthesizer 1804. In some embodiments, the mixer circuitry 1802 and the mixer circuitry 1814 may each include two or more mixers each configured for image rejection (e.g., Hartley image rejection). In some embodiments, the mixer circuitry 1802 and the mixer circuitry 1814 may be arranged for direct down-conversion and/or direct up-conversion, respectively. In some embodiments, the mixer circuitry 1802 and the mixer circuitry 1814 may be configured for super-heterodyne operation, although this is not a requirement.

Mixer circuitry 1802 may comprise, according to one embodiment: quadrature passive mixers (e.g., for the in-phase (I) and quadrature phase (Q) paths). In such an embodiment, RF input signal 1707 from FIG. 18 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1805 of synthesizer 1804 (FIG. 18). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1707 (FIG. 17) may comprise a balanced signal, although the scope of the embodiments is not limited in this respect. The I and Q baseband output signals may be provided to low-noise amplifier, such as amplifier circuitry 1806 (FIG. 18) or to filter circuitry 1808 (FIG. 18).

In some embodiments, the output baseband signals 1807 and the input baseband signals 1811 may be analog baseband signals, although the scope of the embodiments is not limited in this respect. In some alternate embodiments, the output baseband signals 1807 and the input baseband signals 1811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1804 may be a fractional-N synthesizer or a fractional N/N+1 synthesizer, although the scope of the embodiments is not limited in this respect as other types of frequency synthesizers may be suitable. For example, synthesizer circuitry 1804 may be a delta-sigma synthesizer, a frequency multiplier, or a synthesizer comprising a phase-locked loop with a frequency divider. According to some embodiments, the synthesizer circuitry 1804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1804 may be provided by a voltage controlled oscillator (VCO), although that is not a requirement. A divider control input may further be provided by either the baseband processing circuitry 1608a-b (FIG. 16) depending on the desired output frequency 1805. In some embodiments, a divider control input (e.g., N) may be determined from a look-up table (e.g., within a Wi-Fi card) based on a channel number and a channel center frequency as determined or indicated by the example application processor 1610. The application processor 1610 may include, or otherwise be connected to, one of the example secure signal converter 101 or the example received signal converter 103 (e.g., depending on which device the example radio architecture is implemented in).

In some embodiments, synthesizer circuitry 1804 may be configured to generate a carrier frequency as the output frequency 1805, while in other embodiments, the output frequency 1805 may be a fraction of the carrier frequency (e.g., one-half the carrier frequency, one-third the carrier frequency). In some embodiments, the output frequency 1805 may be a LO frequency (fLO).

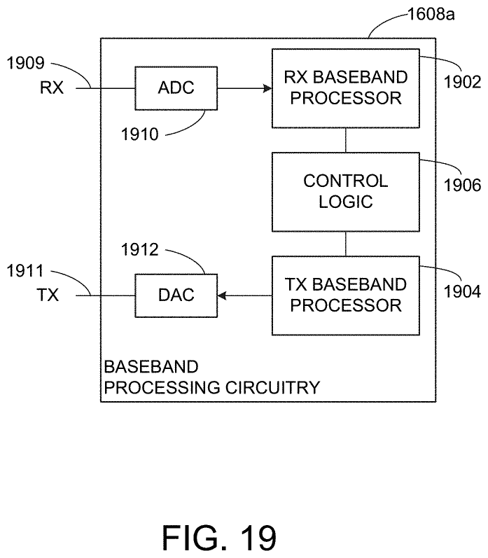

FIG. 19 illustrates a functional block diagram of baseband processing circuitry 1608a in accordance with some embodiments. The baseband processing circuitry 1608a is one example of circuitry that may be suitable for use as the baseband processing circuitry 1608a (FIG. 16), although other circuitry configurations may also be suitable. Alternatively, the example of FIG. 18 may be used to implement the example BT baseband processing circuitry 1608b of FIG. 16.

The baseband processing circuitry 1608a may include a receive baseband processor (RX BBP) 1902 for processing receive baseband signals 1809 provided by the radio IC circuitry 1606a-b (FIG. 16) and a transmit baseband processor (TX BBP) 1904 for generating transmit baseband signals 1811 for the radio IC circuitry 1606a-b. The baseband processing circuitry 1608a may also include control logic 1906 for coordinating the operations of the baseband processing circuitry 1608a.

In some embodiments (e.g., when analog baseband signals are exchanged between the baseband processing circuitry 1608a-b and the radio IC circuitry 1606a-b), the baseband processing circuitry 1608a may include ADC 1910 to convert analog baseband signals 1909 received from the radio IC circuitry 1606a-b to digital baseband signals for processing by the RX BBP 1902. In these embodiments, the baseband processing circuitry 1608a may also include DAC 1912 to convert digital baseband signals from the TX BBP 1904 to analog baseband signals 1911.

In some embodiments that communicate OFDM signals or OFDMA signals, such as through baseband processor 1608a, the transmit baseband processor 1904 may be configured to generate OFDM or OFDMA signals as appropriate for transmission by performing an inverse fast Fourier transform (IFFT). The receive baseband processor 1902 may be configured to process received OFDM signals or OFDMA signals by performing an FFT. In some embodiments, the receive baseband processor 1902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 16, in some embodiments, the antennas 1601 (FIG. 16) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: decode user fields or first portions of unequal modulation and coding scheme (UEM) user fields from a first user specific field; determine resource allocations including a resource unit (RU) or multiple resource unit (MRU) allocations, based on an order of decoded user fields or the first portions of UEM user fields; identify whether a user may be a UEM user based on an indication in a first portion of a UEM user field; and decode a second user specific field to retrieve remaining portions of UEM user fields for UEM users for a full set of modulation and coding schemes (MCSs).

Example 2 may include the device of example 1 and/or some other example herein, wherein the processing circuitry may be further configured to identify UEM users by decoding an extremely high throughput MCS 14 (EHT-MCS 14) indication carried by MCS subfields of 1st portion of UEM user fields in the first user specific field.

Example 3 may include the device of example 1 and/or some other example herein, wherein the processing circuitry may be further configured to locate the remaining portions of UEM user fields in the second user specific field by blindly scanning an identified station identification (STA-ID).

Example 4 may include the device of example 1 and/or some other example herein, wherein the processing circuitry may be further configured to scan the first user specific field to find a user's user field or a first portion of its UEM user field based on its station identification (ID).

Example 5 may include the device of example 1 and/or some other example herein, wherein a user's remaining portions of UEM user fields are always adjacent to each other in the second user specific field.

Example 6 may include the device of example 1 and/or some other example herein, wherein the processing circuitry may be further configured to identify a position of a user's resource unit or multiple resource units (RU or MRU) based on the order of its user field or its first UEM user field portion in the first user specific field.

Example 7 may include the device of example 1 and/or some other example herein, wherein the processing circuitry may be further configured to decode UEM user field portions in the second user specific field using an identified station identification (STA-ID).

Example 8 may include the device of example 1 and/or some other example herein, wherein the processing circuitry may be further configured to decode the first user specific field and the second user specific field sequentially, with the second user specific field providing remaining portions of a UEM user field.

Example 9 may include the device of example 1 and/or some other example herein, wherein the processing circuitry may be further configured to utilize multiple-input multiple-output (MIMO) technology to increase a capacity of wireless transmissions by assigning different MCS values to different spatial streams for UEM users.

Example 10 may include the device of example 1 and/or some other example herein, wherein the processing circuitry may be further configured to adaptively assign multiple MCSs for a UEM user based on channel conditions, interference, and user requirements of its spatial streams.

Example 11 may include the device of example 1 and/or some other example herein, wherein a user field and each portion of UEM user fields have the same length and the same number of bits.

Example 12 may include a non-transitory computer-readable medium storing computer-executable instructions which when executed by one or more processors result in performing operations comprising: decoding user fields or first portions of unequal modulation and coding scheme (UEM) user fields from a first user specific field; determining resource allocations including a resource unit (RU) or multiple resource unit (MRU) allocations, based on an order of decoded user fields or the first portions of UEM user fields; identifying whether a user may be a UEM user based on an indication in a first portion of a UEM user field; and decoding a second user specific field to retrieve remaining portions of UEM user fields for UEM users for a full set of modulation and coding schemes (MCSs).

Example 13 may include the non-transitory computer-readable medium of example 12 and/or some other example herein, wherein the operations further comprise identifying UEM users by decoding an extremely high throughput MCS 14 (EHT-MCS 14) indication carried by MCS subfields of 1st portion of UEM user fields in the first user specific field.

Example 14 may include the non-transitory computer-readable medium of example 12 and/or some other example herein, wherein the operations further comprise locate the remaining portions of UEM user fields in the second user specific field by blindly scanning an identified station identification (STA-ID).

Example 15 may include the non-transitory computer-readable medium of example 12 and/or some other example herein, wherein the operations further comprise scanning the first user specific field to find a user's user field or a first portion of its UEM user field based on its station identification (ID).

Example 16 may include the non-transitory computer-readable medium of example 12 and/or some other example herein, wherein a user's remaining portions of UEM user fields are always adjacent to each other in the second user specific field.

Example 17 may include the non-transitory computer-readable medium of example 12 and/or some other example herein, wherein the operations further comprise identifying a position of a user's resource unit or multiple resource units (RU or MRU) based on the order of its user field or its first UEM user field portion in the first user specific field.

Example 18 may include the non-transitory computer-readable medium of example 12 and/or some other example herein, wherein the operations further comprise decoding UEM user field portions in the second user specific field using an identified station identification (STA-ID).

Example 19 may include the non-transitory computer-readable medium of example 12 and/or some other example herein, wherein the operations further comprise decoding the first user specific field and the second user specific field sequentially, with the second user specific field providing remaining portions of a UEM user field.

Example 20 may include the non-transitory computer-readable medium of example 12 and/or some other example herein, wherein the operations further comprise utilizing multiple-input multiple-output (MIMO) technology to increase a capacity of wireless transmissions by assigning different MCS values to different spatial streams for UEM users.

Example 21 may include the non-transitory computer-readable medium of example 12 and/or some other example herein, wherein the operations further comprise adaptively assign multiple MCSs for a UEM user based on channel conditions, interference, and user requirements of its spatial streams.

Example 22 may include the non-transitory computer-readable medium of example 12 and/or some other example herein, wherein a user field and each portion of UEM user fields have the same length and the same number of bits.

Example 23 may include a method comprising: decoding user fields or first portions of unequal modulation and coding scheme (UEM) user fields from a first user specific field; determining resource allocations including a resource unit (RU) or multiple resource unit (MRU) allocations, based on an order of decoded user fields or the first portions of UEM user fields; identifying whether a user may be a UEM user based on an indication in a first portion of a UEM user field; and decoding a second user specific field to retrieve remaining portions of UEM user fields for UEM users for a full set of modulation and coding schemes (MCSs).

Example 24 may include the method of example 23 and/or some other example herein, further comprising identifying UEM users by decoding an extremely high throughput MCS 14 (EHT-MCS 14) indication carried by MCS subfields of 1st portion of UEM user fields in the first user specific field.

Example 25 may include the method of example 23 and/or some other example herein, further comprising locate the remaining portions of UEM user fields in the second user specific field by blindly scanning an identified station identification (STA-ID).

Example 26 may include the method of example 23 and/or some other example herein, further comprising scanning the first user specific field to find a user's user field or a first portion of its UEM user field based on its station identification (ID).

Example 27 may include the method of example 23 and/or some other example herein, wherein a user's remaining portions of UEM user fields are always adjacent to each other in the second user specific field.

Example 28 may include the method of example 23 and/or some other example herein, further comprising identifying a position of a user's resource unit or multiple resource units (RU or MRU) based on the order of its user field or its first UEM user field portion in the first user specific field.

Example 29 may include the method of example 23 and/or some other example herein, further comprising decoding UEM user field portions in the second user specific field using an identified station identification (STA-ID).

Example 30 may include the method of example 23 and/or some other example herein, further comprising decoding the first user specific field and the second user specific field sequentially, with the second user specific field providing remaining portions of a UEM user field.

Example 31 may include the method of example 23 and/or some other example herein, further comprising utilizing multiple-input multiple-output (MIMO) technology to increase a capacity of wireless transmissions by assigning different MCS values to different spatial streams for UEM users.

Example 32 may include the method of example 23 and/or some other example herein, further comprising adaptively assign multiple MCSs for a UEM user based on channel conditions, interference, and user requirements of its spatial streams.

Example 33 may include the method of example 23 and/or some other example herein, wherein a user field and each portion of UEM user fields have the same length and the same number of bits.

Example 34 may include an apparatus comprising means for: decoding user fields or first portions of unequal modulation and coding scheme (UEM) user fields from a first user specific field; determining resource allocations including a resource unit (RU) or multiple resource unit (MRU) allocations, based on an order of decoded user fields or the first portions of UEM user fields; identifying whether a user may be a UEM user based on an indication in a first portion of a UEM user field; and decoding a second user specific field to retrieve remaining portions of UEM user fields for UEM users for a full set of modulation and coding schemes (MCSs).

Example 35 may include the apparatus of example 34 and/or some other example herein, further comprising identifying UEM users by decoding an extremely high throughput MCS 14 (EHT-MCS 14) indication carried by MCS subfields of 1st portion of UEM user fields in the first user specific field.

Example 36 may include the apparatus of example 34 and/or some other example herein, further comprising locate the remaining portions of UEM user fields in the second user specific field by blindly scanning an identified station identification (STA-ID).

Example 37 may include the apparatus of example 34 and/or some other example herein, further comprising scanning the first user specific field to find a user's user field or a first portion of its UEM user field based on its station identification (ID).

Example 38 may include the apparatus of example 34 and/or some other example herein, wherein a user's remaining portions of UEM user fields are always adjacent to each other in the second user specific field.

Example 39 may include the apparatus of example 34 and/or some other example herein, further comprising identifying a position of a user's resource unit or multiple resource units (RU or MRU) based on the order of its user field or its first UEM user field portion in the first user specific field.

Example 40 may include the apparatus of example 34 and/or some other example herein, further comprising decoding UEM user field portions in the second user specific field using an identified station identification (STA-ID).

Example 41 may include the apparatus of example 34 and/or some other example herein, further comprising decoding the first user specific field and the second user specific field sequentially, with the second user specific field providing remaining portions of a UEM user field.

Example 42 may include the apparatus of example 34 and/or some other example herein, further comprising utilizing multiple-input multiple-output (MIMO) technology to increase a capacity of wireless transmissions by assigning different MCS values to different spatial streams for UEM users.

Example 43 may include the apparatus of example 34 and/or some other example herein, further comprising adaptively assign multiple MCSs for a UEM user based on channel conditions, interference, and user requirements of its spatial streams.

Example 44 may include the apparatus of example 34 and/or some other example herein, wherein a user field and each portion of UEM user fields have the same length and the same number of bits.

Example 45 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
decode user fields or first portions of unequal modulation and coding scheme (UEM) user fields from a first user specific field;
determine resource allocations including a resource unit (RU) or multiple resource unit (MRU) allocations, based on an order of decoded user fields or the first portions of UEM user fields;
identify whether a user is a UEM user based on an indication in a first portion of a UEM user field; and
decode a second user specific field to retrieve remaining portions of UEM user fields for UEM users for a full set of modulation and coding schemes (MCSs).

2. The device of claim 1, wherein the processing circuitry is further configured to identify UEM users by decoding an extremely high throughput MCS 14 (EHT-MCS 14) indication carried by MCS subfields of 1st portion of UEM user fields in the first user specific field.

3. The device of claim 1, wherein the processing circuitry is further configured to locate the remaining portions of UEM user fields in the second user specific field by blindly scanning an identified station identification (STA-ID).

4. The device of claim 1, wherein the processing circuitry is further configured to scan the first user specific field to find a user's user field or a first portion of its UEM user field based on its station identification (ID).

5. The device of claim 1, wherein a user's remaining portions of UEM user fields are always adjacent to each other in the second user specific field.

6. The device of claim 1, wherein the processing circuitry is further configured to identify a position of a user's resource unit or multiple resource units (RU or MRU) based on the order of its user field or its first UEM user field portion in the first user specific field.

7. The device of claim 1, wherein the processing circuitry is further configured to decode UEM user field portions in the second user specific field using an identified station identification (STA-ID).

8. The device of claim 1, wherein the processing circuitry is further configured to decode the first user specific field and the second user specific field sequentially, with the second user specific field providing remaining portions of a UEM user field.

9. The device of claim 1, wherein the processing circuitry is further configured to utilize multiple-input multiple-output (MIMO) technology to increase a capacity of wireless transmissions by assigning different MCS values to different spatial streams for UEM users.

10. The device of claim 1, wherein the processing circuitry is further configured to adaptively assign multiple MCSs for a UEM user based on channel conditions, interference, and user requirements of its spatial streams.

11. The device of claim 1, wherein a user field and each portion of UEM user fields have the same length and the same number of bits.

12. A non-transitory computer-readable medium storing computer-executable instructions which when executed by one or more processors result in performing operations comprising:
decoding user fields or first portions of unequal modulation and coding scheme (UEM) user fields from a first user specific field;
determining resource allocations including a resource unit (RU) or multiple resource unit (MRU) allocations, based on an order of decoded user fields or the first portions of UEM user fields;
identifying whether a user is a UEM user based on an indication in a first portion of a UEM user field; and
decoding a second user specific field to retrieve remaining portions of UEM user fields for UEM users for a full set of modulation and coding schemes (MCSs).

13. The non-transitory computer-readable medium of claim 12, wherein the operations further comprise identifying UEM users by decoding an extremely high throughput MCS 14 (EHT-MCS 14) indication carried by MCS subfields of 1st portion of UEM user fields in the first user specific field.

14. The non-transitory computer-readable medium of claim 12, wherein the operations further comprise locate the remaining portions of UEM user fields in the second user specific field by blindly scanning an identified station identification (STA-ID).

15. The non-transitory computer-readable medium of claim 12, wherein the operations further comprise scanning the first user specific field to find a user's user field or a first portion of its UEM user field based on its station identification (ID).

16. The non-transitory computer-readable medium of claim 12, wherein a user's remaining portions of UEM user fields are always adjacent to each other in the second user specific field.

17. The non-transitory computer-readable medium of claim 12, wherein the operations further comprise identifying a position of a user's resource unit or multiple resource units (RU or MRU) based on the order of its user field or its first UEM user field portion in the first user specific field.

18. The non-transitory computer-readable medium of claim 12, wherein the operations further comprise decoding UEM user field portions in the second user specific field using an identified station identification (STA-ID).

19. The non-transitory computer-readable medium of claim 12, wherein the operations further comprise decoding the first user specific field and the second user specific field sequentially, with the second user specific field providing remaining portions of a UEM user field.

20. A method comprising:
decoding user fields or first portions of unequal modulation and coding scheme (UEM) user fields from a first user specific field;
determining resource allocations including a resource unit (RU) or multiple resource unit (MRU) allocations, based on an order of decoded user fields or the first portions of UEM user fields;
identifying whether a user is a UEM user based on an indication in a first portion of a UEM user field; and
decoding a second user specific field to retrieve remaining portions of UEM user fields for UEM users for a full set of modulation and coding schemes (MCSs).

21. The method of claim 20, further comprising identifying UEM users by decoding an extremely high throughput MCS 14 (EHT-MCS 14) indication carried by MCS subfields of 1st portion of UEM user fields in the first user specific field.
